(19) United States
(12) Patent Application Publication
(10) Pub. No.: US 2011/0141967 A1
(43) Pub. Date: Jun. 16, 2011

(54) METHODS AND APPARATUS RELATED TO SUBSTANTIALLY REAL-TIME DATA TRANSMISSION AND ANALYSIS FOR SENSORS

(76) Inventors: Sean L. Lane, Sykesville, MD (US); Alexander C. Watson, Severn, MD (US); Stuart M. Gott, Riva, MD (US)

(21) Appl. No.: 12/637,511

(22) Filed: Dec. 14, 2009

(51) Int. Cl. H04W 4/00; G08B 9/00

(52) U.S. Cl. 370/328; 340/286.02

(57) ABSTRACT

In some embodiments, a system includes a mobile base station, multiple sensors, and multiple communication devices. Each sensor is configured to collect sensor data. Each communication device is coupled to at least one of the multiple sensors. Each communication device is coupled to an encryption engine configured to receive and encrypt data from at least one of the multiple sensors. Each communication device is configured to send the sensor data from the respective sensor to the mobile base station.

### BACKGROUND

Embodiments described herein relate generally to data transmission and more particularly to data acquisition from sensors with substantially real-time feedback.

Currently, many sensors are used in various environments. For example, roadside sensors can detect the flow of traffic on a road, audio sensors can record conversations, video sensors (e.g., video cameras) can record video, and biometric sensors can record potentially identifiable information about individuals. Often, such sensors can be useful if the data is timely received and analyzed.

Known sensors can be distributed throughout an area. Such known sensors record data. The recorded data can be later retrieved by an individual for analysis. Often the data is retrieved by the individual after an event sensed by the sensor has occurred. The recorded data is often then sent to a storage or analysis location. Feedback is rarely provided to individuals at the collection point, however. When the data has been transported to the analysis location physically, if an analyst determines that the recorded data pertains to an important event and/or individual, it is often too late to act on the event.

Accordingly, a need exists for substantially real-time transmission and analysis of data received by a sensor. Additionally, a need exists for substantially real-time feedback provided to the sensor and/or to a user of a communication device associated with the sensor.

### SUMMARY

In some embodiments, a system includes a mobile base station, multiple sensors, and multiple communication devices. Each sensor is configured to collect sensor data. Each communication device is coupled to at least one of the multiple sensors. Each communication device is coupled to an encryption engine configured to receive and encrypt data from at least one of the multiple sensors. Each communication device is configured to send the sensor data from the respective sensor to the mobile base station. In some embodiments, the mobile base station is configured to send the sensor data to an analysis location and subsequently receive a substantially real-time response from the analysis location based on the sensor data.

### BRIEF DESCRIPTION OF THE DRAWINGS

FIG. 1 is a schematic illustration of a communication system, according to an embodiment.

FIG. 2 is a schematic illustration of a communication/processing assembly, according to another embodiment.

FIG. 3 is a side view of a communication/processing assembly, according to another embodiment.

FIG. 4 is a schematic illustration of a communication/processing device, according to another embodiment.

FIG. 5 is a flow chart illustrating a method of transmitting data, according to another embodiment.

### DETAILED DESCRIPTION

In some embodiments, a system includes a mobile base station, multiple sensors, and multiple communication devices. Each sensor is configured to collect sensor data. Each communication device is coupled to at least one of the multiple sensors. Each communication device is coupled to an encryption engine configured to receive and encrypt data from at least one of the multiple sensors. Each communication device is configured to send the sensor data from the respective sensor to the mobile base station.

In some embodiments, the sensors and the communication devices can be distributed throughout a battlefield. In such embodiments, the communication devices can send the sensor data to an analysis location in substantially real-time for analysis. In other embodiments, the sensors and the communication devices are a part of a handheld assembly used by a user. In such embodiments, the user can use the sensor to collect sensor data to be sent to the analysis location for analysis. In some embodiments, the user can receive, in substantially real-time, a response from the analysis location as a result of the analysis at the analysis location. Such a response can be associated with the user taking a particular action. In some embodiments, the response can be, for example, an alert, a task to be performed, a notification, or other response.

As used herein, “real-time” or “substantially real-time” means that information is sent from and/or received by a device, user, analyst, client, or other entity or object with a temporal delay sufficiently short to preserve the information's utility. For example, in some embodiments a sensor or data collection device can send information to an analysis location and receive a response, instruction, or analysis based at least in part on the information sent and/or received in substantially real-time, i.e. after a time delay that allows a user of the collection device to perform some action based on the response within a desired time window. A desired time window can be, for example, a specified number of minutes, a specified number of hours, etc. In some embodiments, a desired time window can be based on an amount of time during which a user of the collection device has interaction with a specified individual, location, object, etc.

In some embodiments, an apparatus includes a housing, an encryption engine, an antenna engine and a processor. The encryption engine is configured to encrypt data and is removably disposed within the housing. The antenna engine is configured to operatively couple the apparatus to a mobile cellular network. The antenna engine is disposed within the housing. The processor is configured to receive data in a first format from the encryption engine, re-bundle the data for a specified transport medium, and send the data in the re-bundled form to the antenna engine. The processor is disposed within the housing. The antenna engine is configured to send the encrypted data via the mobile cellular network.

In some embodiments, a processor-readable medium stores code representing instructions configured to cause a processor to receive a first signal associated with encrypted sensor data in a first format from an encryption engine that received unencrypted sensor data from a processing device. The processor-readable medium further stores code to cause the processor to reformat the encrypted sensor data into a second format compatible with an antenna engine and send a second signal associated with the encrypted sensor data in the second format to the antenna engine. The antenna engine is configured to transmit a third signal representing the encrypted sensor data in the second format to a location remote from the processing device in response to receiving the second signal.

As used in this specification, the singular forms “a,” “an” and “the” include plural referents unless the context clearly dictates otherwise. Thus, for example, the term “a communication device” is intended to mean a single communication device or a combination of communication devices.

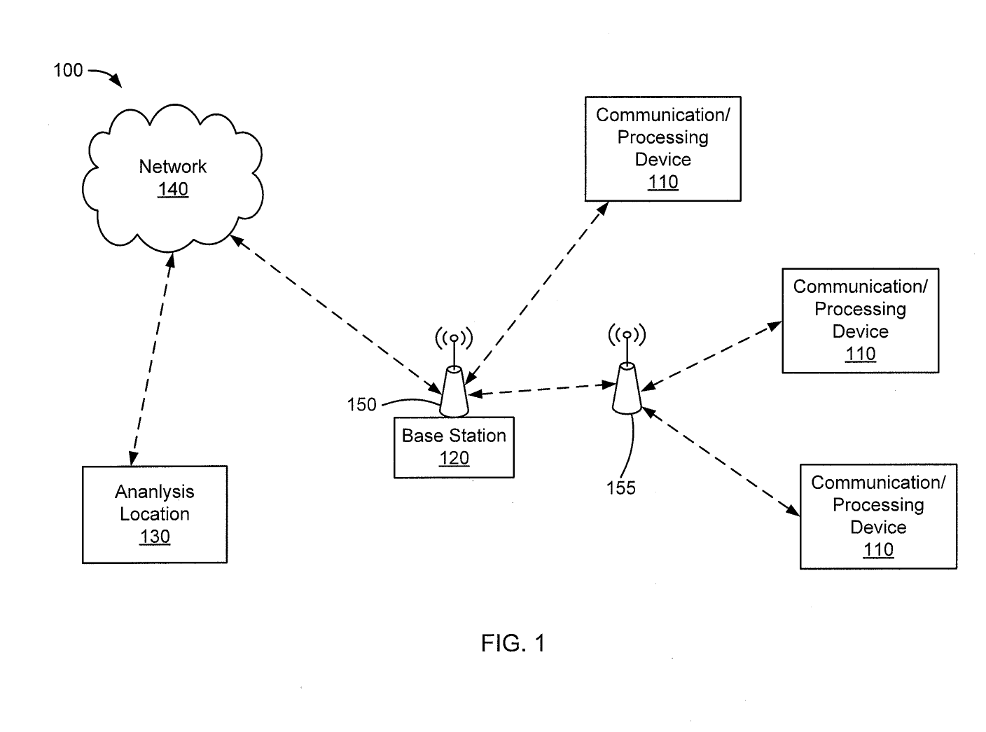

FIG. 1 is a schematic illustration of a communication system 100, according to an embodiment. The communication system 100 includes multiple communication/processing devices 110, multiple gateway devices 150, 155, a base station 120, a back-end network 140 and an analysis location 130. Each of the communication/processing devices 110 can be, for example, a computing entity (e.g., a personal computing device such as a desktop computer, a laptop computer, etc.), a mobile phone, a monitoring device, a personal digital assistant (PDA), a sensor system and/or the like. Although not shown in FIG. 1, in some embodiments, each of the communication/processing devices 110 can include one or more antenna engines (e.g., a network interface card, an Air card, and/or the like) configured to connect the communication/processing devices 110 to the gateway devices 150, 155.

In some embodiments, each communication/processing device 110 can include and/or be operatively coupled to at least one sensor. In some embodiments, the sensor can be a biometric sensor, a vibration sensor, a temperature sensor, a video camera, a thermal camera, a motion detector, and/or any other type of sensor. In such embodiments, the communication/processing devices 110 can obtain data from the sensors and send the data to an analysis location 130 for analysis, as described in further detail herein.

In other embodiments, each communication/processing device 110 can include an input port to receive data. Such an input port can be any suitable input port such as, for example, a Universal Serial Bus (USB) port, an Ethernet port, an RS-232 port, and/or the like. In such embodiments, data obtained from a sensor can be transferred to a communication/processing device 110 via the input port.

In some embodiments, the communication/processing devices 110 can be handheld devices used by individuals. In such embodiments, a user can interact with, input data to, and/or view data using the communication/processing devices 110, as described in further detail herein. In such embodiments, the users can be individuals within a hostile or crowd-control environment, such as, for example, a battlefield, an underwater environment, a police environment, a sporting event, and/or the like. In other embodiments, the communication/processing devices 110 can be distributed sensors throughout an area. For example, the communication/processing devices 110 can be sensors distributed throughout a hostile or crowd-control environment. In such embodiments, the sensors can be configured to monitor environmental conditions (including activity) over a period of time.

In some embodiments, each communication/processing device 110 can include an encryption engine (not shown in FIG. 1). The encryption engine can be configured to encrypt data prior to sending the data to the gateway devices 150, 155. In some embodiments, the encryption engine can be a High Assurance Internet Protocol Encryptor (HAIPE) such as a Talon Card from L3 Communications. In other embodiments, any other type of HAIPE can be used. For example, the encryption engine can be a Type 1 encryption device used to transmit and receive classified information. In other embodiments, the encryption engine can be any other type of encryptor. The communication/processing devices 110 are described in further detail herein.

The gateway devices 150, 155 can be any type of device that establishes a wireless network. In some embodiments, for example, the gateway devices 150, 155 can define a cellular network. As such the gateway devices 150, 155 can act as cellular telephone towers. In such embodiments, the gateway devices 150, 155 are distributed throughout an area such that a cellular network is defined within that area. This allows the communication/processing devices 110 to connect to a gateway device 150, 155 that is within the same geographic area as the communication/processing device 110. As such, some communication/processing devices 110 are operatively coupled to the gateway device 150 and some communication/processing devices 110 are operatively coupled to the gateway device 150. In other embodiments, the gateway devices 150, 155 define any other type of wireless network, such as, for example, a wireless local area network (WLAN), a wireless metropolitan area network (MAN) and/or the like. In some embodiments, the gateway device 155 can be a local area network configured to relay information to and from at least one communication/processing device 110 that is physically located beyond the communicable reach of gateway device 150. In still other embodiments, the network defined by the gateway devices can be similar to the networks shown and described in U.S. Pat. No. 7,486,967 to Pan, filed Nov. 8, 2004, and entitled “System, Method and Device for Providing Communications Using a Distributed Mobile Architecture;” U.S. Pat. No. 7,539,158 to Pan, filed Nov. 8, 2004, and entitled “System, Method and Device for Providing Communications Using a Distributed Mobile Architecture;” and/or U.S. Pat. No. 7,548,763 to Pan, filed Apr. 13, 2005, and entitled “System, Method and Device for Providing Communications Using a Distributed Mobile Architecture,” each of which is incorporated herein by reference in its entirety.

Additionally, the gateway devices 150, 155 can be operatively coupled to each other. This allows the gateway devices 150, 155 to send and receive signals from the other gateway devices 150, 155. Such interconnectivity between the gateway devices 150, 155 defines a mesh network between the gateway devices 150, 155. In other embodiments, the gateway devices are not operatively coupled to each other and, as such, do not define a mesh network.

In some embodiments, the gateway devices 150, 155 are mobile gateway devices. In such embodiments, for example, the gateway devices can be mobile cellular antennas. As such, the mobile cellular antennas can be placed throughout an area such that a mobile ad hoc cellular network is defined. This allows the mobile network to be easily constructed, expanded, moved and/or deconstructed as needed. In some embodiments, for example, such a mobile ad hoc cellular network can be erected within a battlefield environment. This allows soldiers and other military personnel using the communication/processing devices 110 to communicate with other soldiers and military personnel and/or with an analysis location 130, using the cellular network. Additionally, soldiers and other military personnel can view data received by sensors coupled to communication/processing devices 110 distributed throughout the battlefield environment.

In some embodiments, a gateway device 150 is located at a base station 120. The base station 120 can be a control center for the cellular network. In such embodiments, signals transmitted to and/or from the communication/processing devices 110 can be routed through the base station 120. For example, in some embodiments, signals containing data to be sent from a communication/processing device 110 to an analysis location 130 can be routed through the base station 120, as described in further detail herein. In some embodiments, signals sent between two or more communication/processing devices 110 can also be routed through the base station 120.

The base station 120 can include a transceiver configured to operatively couple the base station 120 to a back-end network 140. As such, the base station 120 can send and receive signals via the back-end network 140. In such a manner, the base station 120 can send signals to and receive signals from an analysis location 130 at a location remote from the cellular network via the back-end network 140.

The analysis location 130 can be, for example, an analysis center where data received from the communication/processing devices 110 can be analyzed. In some embodiments, the analysis location can be a private analysis center where data is received and analyzed. In some embodiments, the analysis location 130 can be a computer database stored in hardware and/or software and capable of analysis by an individual, another hardware and/or software module, etc. As shown in FIG. 1, in some embodiments, the analysis location 130 can be disposed remote from the area defined by the cellular network. As described in further detail herein, the analysis location 130 can send signals to the communication/processing devices 110 after analyzing data received from the communication/processing devices 110 within a time period after the communication/processing device 110 receives the sensor data. Such a signal sent in response to analyzing data can be associated with a indication to a user of a communication/processing device 110 to take a particular action. This allows the user to perform an action within a time period after the communication/processing device 110 receives the sensor data. As such, each communication/processing device 110 is configured to transmit data to and receive data from the analysis location 130 via the gateway devices 150, 155 and the back-end network 140, as described in further detail herein.

The back-end network 140 can be, for example, a satellite backhaul network that includes an orbital satellite configured to exchange information with at least the base station 120 and the analysis location 130. In some embodiments, the back-end network can be a fiber-optic network that includes at least one network device and/or server configured to exchange information with the base station 120 and the analysis location 130. In other embodiments, the back-end network 140 can be any other suitable network capable of exchanging information between remote devices such as base station 120 and at least one network device located at analysis location 130 such as, for example, a cellular network, the Internet, a LAN, a WAN, a MAN and/or the like. Such networks can include wireless and/or wired portions.

In use, a communication/processing device 110 receives data to be sent to the analysis location 130 for analysis. As described above, in some embodiments the communication/processing device 110 includes a sensor that senses data. In other embodiments, a user transfers data from a sensor to the communication/processing device 110 using any suitable connection.

In some embodiments, for example, the communication/processing device 110 includes a biometric fingerprint scanner. In such embodiments, a user of the communication/processing device 110 will instruct an individual to place their finger on the fingerprint scanner. The communication/processing device 110 can then obtain data associated with the individual's fingerprint.

In other embodiments, the user of the communication/processing device can insert a memory scanner (e.g., a USB memory stick storing a memory scanner program) into a computing device (e.g., a personal computer, a laptop, a cellular phone, etc.). Such a memory scanner can scan the computing device for data (e.g., a media access control (MAC) address, information stored on the computer, etc.). After the memory scanner has completed scanning the computing device, the user of the communication/processing device 110 can insert the memory scanner into a port of the communication/processing device 110 to obtain the data associated with the computing device from the memory scanner. In still other embodiments, any other scanner and/or sensor internal or external to the communication/processing device 110 can be used to obtain data.

Using the encryption engine, the communication/processing device 110 can encrypt the data. Because the encryption engine can be a HAIPE, the encryption engine can prepare data to be sent over the cellular network without allowing other users of the cellular network to access or eavesdrop on the data. Using the antenna engine, a signal associated with the encrypted data is transmitted to a gateway device 150, 155. If the gateway device 155 is not collocated with the base station 120, the signal associated with the encrypted data is routed through additional gateway devices 155 until the signal reaches the gateway device 150 collocated with the base station 120. The base station 120 can then send the signal associated with the encrypted data to the analysis location 130 via the satellite.

The data can be decrypted and analyzed at the analysis location 130. For example, if the data is biometric data, a database containing information associating the identity of persons with their biometric data can be scanned for a possible match. In another example, if the data is associated with a MAC address of a scanned computer, a database containing information associating the identity of persons with MAC addresses can be scanned for a possible match. In other embodiments, any other type of analysis can be performed at the analysis location 130.

Based on the analysis at the analysis location 130, a course of action can be determined. An instruction associated with the course of action can be encrypted and a signal associated with the instruction sent to the communication/processing device 110 via the back-end network 140, the base station 120, and the gateway devices 150, 155. The antenna engine within the communication/processing device 110 can receive the signal and send the instruction to the encryption engine. The encryption engine can decrypt the instruction and provide an indication to a user of the communication/processing device 110 of the course of action. In other embodiments, the instruction is sent to a communication/processing device 110 (or another device) other than the communication/processing device 110 that sent the data to the analysis location 130. For example, if a communication/processing device 110 is coupled to a remote sensor, the communication/processing device 110 can send data acquired by the sensor to the analysis location 130. The analysis location 130 can then send an instruction to a user of another communication/processing device 110 to perform an action based on the data acquired by the remote sensor.

In some embodiments, the instruction can be conveyed to the user of the communication/processing device 110 using a display. In some embodiments, for example, the display includes at least two indicators: a first indicator associated with a first action and a second indicator associated with a second action. If the analysis reveals that the first action is to be taken, the signal sent to the communication/processing device 110 from the analysis location 130 can cause the first indicator to be displayed. Similarly, if the analysis reveals that the second action is to be taken, the signal sent to the communication/processing device 110 from the analysis location 130 can cause the second indicator to be displayed. In such embodiments, for example, an activated first indicator can represent to the user that the user is to take a specified action and an activated second indicator can represent to the user that the user is not to take a specified action.

Similarly, instead of using two indicators, in other embodiments, a directed course of action can be conveyed to the user of the communication/processing device 110 using any number of indicators representing any number of actions to be taken by the user. In such embodiments, for example, five indicators can be used. In such embodiments, at least one of the five indicators can be displayed on the display in response to receiving the signal associated with the analysis from the analysis location 130. For example, the indicators can be star-shaped and indicate a level of danger or course of action. For example, one star can indicate no danger and no action to be taken while five stars can indicate a high level of danger and a significant action to be taken. In other embodiments, any number of indicators having any suitable shape and/or color can be used.

While shown and described in FIG. 1 as having multiple gateway devices 150, 155, in other embodiments, the communication system can include a single gateway device. Similarly, while shown and described in FIG. 1 as having a single base station 120, in other embodiments, the communication system can include multiple base stations in communication with a network.

Additionally, while shown and described in FIG. 1 as having a separate base station 120 and analysis location 130, in other embodiments, the analysis location is collocated with the base station. In such embodiments, the analysis of the data received from the communication/processing devices can be performed at the base station/analysis location and the satellite communicatively linking the base station with the analysis location in not needed. In still other embodiments, some of the analysis is performed at the base station while additional analysis is performed at the analysis location depending on the type of analysis to be performed.

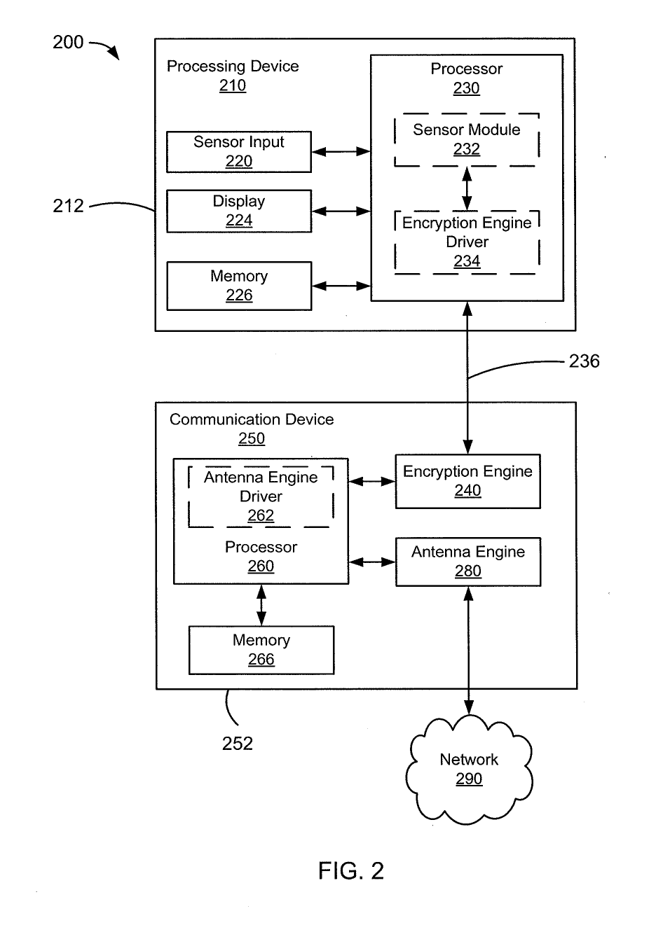

FIG. 2 is a schematic illustration of a communication/processing assembly 200, according to another embodiment. The communication/processing assembly 200 includes a processing device 210 and a communication device 250. In such embodiments, the processing device 210 is within a first housing 212 and the communication device 250 is in a second housing 252. In some embodiments, the first housing 212 can be physically coupled to the second housing 252, as described in further detail herein. As described in further detail herein, in other embodiments, the processing device 210 and the communication device 250 can be disposed within the same housing.

The processing device 210 is configured to receive sensor data and provide the sensor data to the communication device 250. The communication device 250 is configured to encrypt the sensor data and send the sensor data to the network 290. As discussed above, in some embodiments, the network 290 is a cellular network. In other embodiments, the network 290 can be any suitable network, such as a local area network (LAN), a wireless local area network (WLAN), a wide area network (WAN), a metropolitan area network (MAN), and/or the like. The processing device 210 can be operatively coupled to the communication device via the connection 236. In some embodiments, the connection 236 is an Ethernet connection. In other embodiments, the connection 236 can be any other type of connection.

The processing device 210 can include a sensor input 220, a display 224, a memory 226 and a processor 230. The processor 230 can be any suitable processor configured to receive sensor data and send the sensor data to the communication device. In some embodiments, for example, the processor 230 can be a microcontroller, a field-programmable gate array (FPGA), an application specific integrated circuit (ASIC), and/or any other suitable processor.

The memory 226 can be any suitable memory. In some embodiments, for example, the memory can be random-access memory (RAM), read-only memory (ROM), flash memory, erasable programmable read-only memory (EPROM), electrically erasable programmable read-only memory (EEPROM), and/or the like. In some embodiments, the memory 226 is configured to store code representing processor instructions and/or data received from the sensor and/or the communication device 250.

The display 224 can be any suitable display. In some embodiments, for example, the display 224 is a liquid crystal display (LCD). In other embodiments, the display 224 includes one or more light emitting diodes (LEDs). In yet other embodiments, the processing device does not include a display. In some embodiments, instead of and/or in addition to a display, the processing device can include a speaker, a haptic indicator (e.g., a vibration device) and/or any other output device configured to communicate to the user.

In some embodiments, the sensor input 220 can be an input port through which sensor data can be input into the processing device 210. As discussed above, the input port can be any suitable input port, such as, for example, a USB port, an Ethernet port, an RS-232 port, and/or the like. Through such an input port, an external sensor can be operatively coupled to the processing device 210. In some embodiments, for example, the sensor can be a biometric sensor, a vibration sensor, a temperature sensor, a video camera, a thermal camera, a motion detector, and/or any other type of sensor. Further, through such an input port, a memory device containing sensor data can be operatively coupled to the processing device 210. A sensor module 232, stored within the memory 226 and run by the processor 230, can be used to receive the sensor data from the sensor input 220 and process the sensor data (e.g., store, send to other modules, perform processing, etc.). In other embodiments, the sensor input 220 can be replaced by a sensor itself. In such embodiments, the sensor is part of the processing device and the sensor module 232 can be used to receive the sensor data from the sensor.

The communication device 250 includes an encryption engine 240, a processor 260, a memory 266 and an antenna engine 280. The encryption engine 240 can be any suitable encryption device and can include hardware and/or a combination of hardware and software. In some embodiments, the encryption engine 240 can be a High Assurance Internet Protocol Encryptor (HAIPE) such as a Talon Card from L3 Communications. In other embodiments, the encryption engine 240 can be any other type of HAIPE. For example, the encryption engine 240 can be a Type 1 encryption device used to encrypt and/or decrypt classified data. In other embodiments, the encryption engine 240 can be any other type of encryptor.

In some embodiments, the encryption engine 240 is removably disposed within the second housing 252. For example, the second housing 252 can include a Personal Computer Memory Card International Association (PCMCIA) slot in which the encryption engine 240 can be inserted. As such, the encryption engine 240 can be removed from the second housing 252 when it is not needed. In other embodiments, the encryption engine 240 can be inserted into a USB port and/or any other port. In some embodiments, when the encryption engine 240 is removed from the second housing, the processor 230 can send the sensor data directly to the processor 260, bypassing the encryption engine 240. In such embodiments, the antenna engine 280, described in further detail herein, can transmit unencrypted sensor data. In still other embodiments, the encryption engine 240 is fixedly disposed within the housing.

The encryption engine 240 can be driven by an encryption engine driver 234 stored within the memory 226 and executed by the processor 230. The encryption engine driver 234 can be software stored within the memory 226 provided with and configured to control the encryption engine 240. As described in further detail herein, the encryption engine driver 234 can cause the processor 230 to instruct the encryption engine 240 to encrypt and/or decrypt data. Additionally, the encryption engine driver 234 can cause the processor 230 to format data into a format accepted by the encryption engine 240. Accordingly, the encryption engine 240 is disposed within the communication device 250 and is driven by the processor 230 disposed within the processing device 210.

The antenna engine 280 can be any suitable device configured to transmit data over the network 290 and can include hardware and/or a combination of hardware and software. In some embodiments, the antenna engine 280 can include a network interface card, an Air card, and/or the like. In such embodiments, the antenna engine 280 can also include an antenna. Accordingly, through the antenna engine 280, the communication device 250 can be operatively coupled to the network 290.

The processor 260 can be structurally similar to the processor 230 and the memory 266 can be structurally similar to the memory 226. In some embodiments, the processor 260 and the processor 230 can be a single processor configured to perform the tasks of both processor 260 and processor 230. The processor 260 can be configured to execute an antenna engine driver 262 to drive the antenna engine 280. The antenna engine driver 262 can be software stored within the memory 266 provided with and configured to control the antenna engine 280. Specifically, the processor 260, running the antenna engine driver 262, can be configured to receive a signal associated with data in a first format from the encryption engine 240 (e.g., a format in which the encryption engine 240 outputs data), reformat the data into a second format (e.g., a format in which the antenna engine 280 receives data) and send a signal associated with the data in the second format to the antenna engine 280, as described in further detail herein. Additionally, the antenna engine driver 262 can cause the processor 260 to instruct the antenna engine 280 to send signals to the network 290.

In use, sensor data is input to the processing device 210 via the sensor input 220. As discussed above, in some embodiments, a sensor and/or a memory containing sensor data can be coupled to the sensor input 220. The sensor module 232 is executed by the processor 230 to control the input of the sensor data. In some embodiments, the processor 230 can cause the sensor data to be stored in the memory 226. Additionally, in some embodiments, the processor 230 can cause the sensor data to be displayed to the user on the display 224. In such embodiments, depending on the type of sensor data (e.g., location, identity, sound levels, video, etc.) the sensor data can be displayed on the display 224 in any suitable format, such as, for example, a spreadsheet, a graph, a map, a video, and/or the like.

The sensor module 232 can send a signal associated with the data to the encryption engine driver 234. The encryption engine driver 234 can format the data into a format compatible with the encryption engine 240. Similarly stated, the encryption engine driver 234 can prepare the data to be sent to the encryption engine 240.

The processor 230 (while running the encryption engine driver 234) sends a signal associated with the formatted data to the encryption engine 240 via the connection 236. In some embodiments, various control signals (e.g., handshaking signals, ready signals, etc.) are also sent between the processor 230 and the encryption engine 240 prior to and/or following the processor 230 sending the signal associated with the formatted data to the encryption engine 240. Using the control signals, the processor 230 can instruct the encryption engine 240 to encrypt the formatted data.

The encryption engine 240 receives the signal associated with the formatted data via the connection 236 and encrypts the data. The encrypted data is then sent to the processor 260 in another format. In some embodiments, the encrypted data is sent to the processor 260 in an Ethernet format. In other embodiments, the encrypted data can be sent to the processor in any other suitable format.

The processor 260, running the antenna engine driver 262, receives the encrypted data from the encryption engine 240 and reformats the encrypted data into a format compatible with the antenna engine 280. Similarly stated, the antenna engine driver 262 prepares the encrypted data to be sent to the antenna engine 280. After the processor 260 reformats the encrypted data, the encrypted data is sent to the antenna engine 280. The antenna engine 280 sends the data to the network 290.

In some embodiments, as described above, the encrypted data is sent over the network to an analysis location. The data can be decrypted and analyzed at the analysis location. For example, if the data is associated with a fingerprint, a database containing information associating the identity of persons with data associated with their fingerprints can be scanned for a possible match. For another example, if the data is associated with a MAC address of a scanned computer, a database containing information associating the identity of persons with MAC addresses can be scanned for a possible match. In other embodiments, any other type of analysis can be performed at the analysis location.

Based on the analysis at the analysis location, a course of action can be determined. An instruction associated with the course of action can be encrypted and a signal associated with the instruction sent in substantially real-time to the communication device 250 via the network 290. The antenna engine 280 within the communication device 250 can receive the signal. The antenna engine 280 can send a signal associated with the instruction to the processor 260.

The processor 260, running the antenna engine driver 262, can reformat the signal associated with the course of action into a format compatible with the encryption engine 240. In some embodiments, this format can be the format in which the encryption engine 240 sent the encrypted data to the processor 260. For example, the signal can be reformatted into an Ethernet signal. In other embodiments, the signal associated with the course of action can be reformatted into any format accepted by the encryption engine 240.

The encryption engine 240 receives the signal from the processor 260 and decrypts the instruction associated with the signal. A signal associated with the decrypted instruction can then be sent to the processor 230. The processor 230, running the encryption engine driver 234, can reformat the decrypted instruction into a format compatible with other modules run by the processor 230.

In some embodiments, the processor 230 can store the instruction in the memory 226 and/or display the instruction on the display 224. In such embodiments, the display can provide an indication to a user of the communication/processing assembly 200 of an action to take. For example, in some embodiments, the display 224 presents one of five levels of action to the user. In such embodiments, level one can be the least urgent (e.g., take no action) while level five can be the most urgent and/or critical (e.g., detain an individual). The intermediate levels can represent actions in-between level one and level five. Accordingly, if a user of the communication/processing assembly 200 obtains an individual's fingerprint and a level five indication is provided as a result of the analysis at the analysis location, the user of the communication/processing assembly 200 can, for example, detain the individual. In such embodiments, the levels can be represented on the display 224 as different colors, shapes, and/or the like. In other embodiments, only two levels are used: take no action and take action. In still other embodiments, any number of levels representing any number of courses of action can be used.

Using a multiple level display, a user of the communication/processing assembly 200 can be instructed to take an action without knowing the underlying reasons for the action. Similarly stated, the analysis performed at the analysis location can be kept classified while an unclassified instruction resulting from the analysis is conveyed to the user. For example, the user of the communication/processing assembly 200 only knows of the instruction to detain an individual but does not know the identity of that individual.

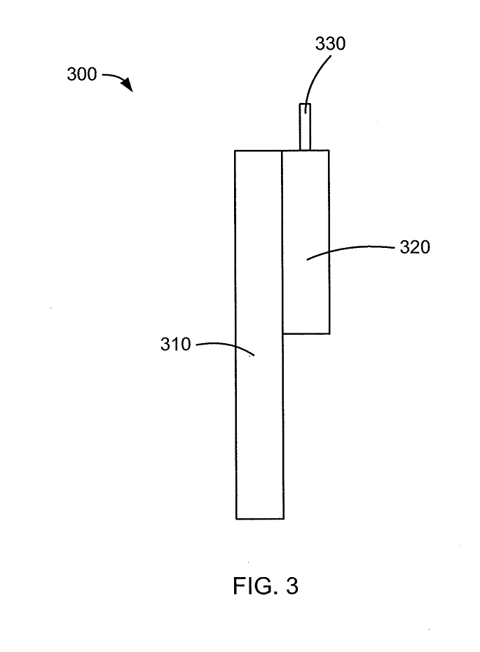

FIG. 3 is a side view of a communication/processing assembly 300 similar to the communication/processing assembly 200, shown and described above. The communication/processing assembly 300 includes a first housing 310 and a second housing 320. The first housing 310 contains a processing device similar to the processing device 210, shown and described above. The processing device can include, for example, a legacy sensor that, without a communication device attached, is not operatively coupled to a network.

The second housing 320 contains a communication device similar to the communication device 220 shown and described above. The communication device further includes an antenna 330 as part of an antenna engine, and an encryption engine (not shown in FIG. 3). In some embodiments, the antenna engine and/or the encryption engine can be removably disposed within the second housing 320. In some embodiments, for example, the second housing 320 can include one or more PCMCIA slots in which the encryption engine and/or the antenna engine can be inserted. As such, the encryption engine and/or the antenna engine can be removed from the second housing 320 when not needed. In other embodiments, the encryption engine and/or the antenna engine can be inserted into a USB port and/or any other type of port. In still other embodiments, the encryption engine and/or the antenna engine is fixedly disposed within the housing.

The second hosing 320 can be coupled to the first housing such that the processing device within the first housing 310 is operatively coupled to the communication device within the second housing 320. More specifically, the processor within the processing device of the first housing 310 can be operatively coupled to the encryption engine within the housing 320.

The connection between the processing device and the communication device can be any suitable connection. In some embodiments, for example, the communication device can include at least one protrusion (e.g., a pin) and the processing device can define at least one aperture configured to accept the protrusion to define an electrical connection. In other embodiments, for example, any other connection mechanism can be used, such as, for example, a USB connector, an Ethernet connector, and/or the like.

Additionally, the second housing 320 can be physically coupled to the first housing 310 such that the second housing 320 cannot move with respect to the first housing 310. Similarly stated, the second housing 320 can be fixedly coupled to the first housing 310. In some embodiments, for example, the second housing 320 can be coupled to the back of the first housing 310 using any suitable coupler. For example, the second housing 320 can be coupled to the first housing 310 using screws, Velcro, glue, a snap-connector, a strap, and/or the like. In other embodiments, the second housing 320 can be removably coupled to the first housing 310 using any suitable coupler. In such embodiments, the second housing 320 can be detached from the first housing 310.

In use, the communication/processing assembly 300 functions substantially similar to the communication/processing assembly 200. As such, the processing device within the first housing 310 receives sensor data and the communication device within the second housing 320 encrypts and transmits the sensor data over a network. Existing sensors (e.g., legacy sensors) can be retrofitted with such a second housing and put in communication with the network such that data can be transmitted and analyzed in substantially real-time.

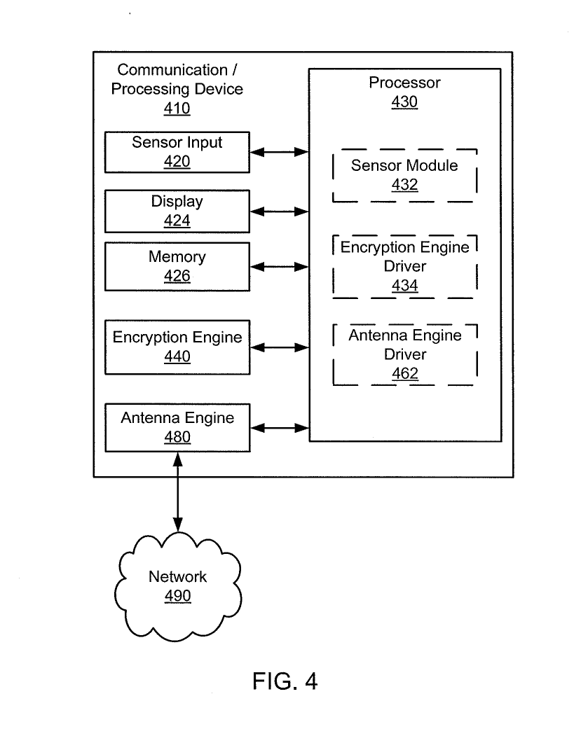

While shown and described above as being two separate devices, in some embodiments, the processing device and the communication device can be a single device. FIG. 4, for example, is a schematic illustration of a communication/processing device 410, according to another embodiment. The communication/processing device 410 is functionally similar to the communication/processing assembly 200 shown and described above.

The communication/processing device 410 includes a processor 430, a sensor input 420, a display 424, a memory 426, an encryption engine 440 and an antenna engine 480. The sensor input 420, the display 424, the memory 426, the encryption engine 440 and the antenna engine 480 are structurally and functionally similar to the sensor input 220, the display 224, the memory 226, the encryption engine 240 and the antenna engine 280, shown and described above. The processor 430 is structurally similar to the processors 230, 260 shown and described above. Functionally, the processor 430 performs the operations of both the processor 230 and the processor 260, as described in further detail herein.

In use, sensor data is input to the communication/processing device 410 via the sensor input 420. In some embodiments, a sensor and/or a memory containing sensor data can be coupled to the sensor input 420. The sensor module 432 is executed by the processor 430 to control the input of the sensor data. In some embodiments, the processor 430 can cause the sensor data to be stored in the memory 426. Additionally, in some embodiments, the processor 430 can cause the sensor data to be displayed to the user on the display 424. In such embodiments, depending on the type of sensor data (e.g., location, identity, sound levels, video, etc.) the sensor data can be displayed on the display 424 in any suitable format, such as, for example, a spreadsheet, a graph, a map, a video, and/or the like.

The sensor module 432 can send a signal associated with the data to the encryption engine driver 434. The encryption engine driver 434 can format the data into a format compatible with the encryption engine 440. Similarly stated, the encryption engine driver 434 can prepare the data to be sent to the encryption engine 440.

The processor 430 (while running the encryption engine driver 434) sends a signal associated with the formatted data to the encryption engine 440. In some embodiments, various control signals (e.g., handshaking signals, ready signals, etc.) are also sent between the processor 430 and the encryption engine 440 prior to and/or following the processor 430 sending the signal associated with the formatted data to the encryption engine 440. As such, the processor 430 can instruct the encryption engine 440 to encrypt the formatted data.

The encryption engine 440 receives the signal associated with the formatted data and encrypts the data. The encrypted data is then sent back to the processor 430 in another format. In some embodiments, the encrypted data is sent back to the processor 430 in an Ethernet format. In other embodiments, the encrypted data can be sent back to the processor 430 in any other suitable format.

The processor 430, running the antenna engine driver 462, receives the encrypted data from the encryption engine 440 and reformats the encrypted data into a format compatible with the antenna engine 480. Similarly stated, the antenna engine driver 462 prepares the encrypted data to be sent to the antenna engine 480. After the processor 460 has reformatted the encrypted data, the encrypted data is sent to the antenna engine 480. The antenna engine 480 sends the data to the network 490. The network 490 can be structurally and functionally similar to the network 290, shown and described above.

In some embodiments, as described above, the encrypted data is sent over the network 490 to an analysis location. The data can be decrypted and analyzed at the analysis location. For example, if the data is associated with a fingerprint, a database containing information associating the identity of persons with their fingerprints can be scanned for a possible match. For another example, if the data is associated with a MAC address of a scanned computer, a database containing information associating the identity of persons with MAC addresses can be scanned for a possible match. In other embodiments, any other type of analysis can be performed at the analysis location and/or any other suitable location (e.g., a base station).

Based on the analysis at the analysis location, a course of action can be determined. An instruction associated with the course of action can be encrypted and a signal associated with the instruction sent in substantially real-time to the communication/processing device 410 via the network 490. The antenna engine 480 within the communication/processing device 450 can receive the signal. The antenna engine 480 can send a signal associated with the instruction to the processor 430.

The processor 430, running the antenna engine driver 462, can reformat the signal associated with the instruction into a format compatible with the encryption engine 440. In some embodiments, this format can be the format in which the encryption engine 440 sent the encrypted data to the processor 430. For example, the signal can be reformatted into an Ethernet signal. In other embodiments, the signal associated with the instruction can be reformatted into any format accepted by the encryption engine 440.

The encryption engine 440 receives the appropriately formatted signal associated with the instruction from the processor 430 and decrypts the instruction. The encryption engine can send a signal associated with the decrypted instruction to the processor 430. The processor 430, running the encryption engine driver 434, can reformat the decrypted instruction into a format compatible with other modules run by the processor 430.

In some embodiments, the processor 430 can store the data associated with the instruction in the memory 426 and/or display the data on the display 424. In such embodiments, the display can provide an indication to a user of the communication/processing device 410 of an action to take. For example, in some embodiments, the display 424 presents one of five levels of action to the user. In such embodiments, level one can be the least urgent (e.g., take no action) while level five can be the most urgent and/or critical (e.g., detain an individual). The intermediate levels can represent actions in-between level one and level five. Accordingly, if a user of the communication/processing device 410 obtains an individual's fingerprint and a level five indication is provided as a result of the analysis at the analysis location, the user of the communication/processing device 400 can, for example, detain the individual. In such embodiments, the levels can be represented on the display 424 as different colors, shapes, and/or the like. In other embodiments, only two levels are used: take no action and take action. In still other embodiments, any number of levels representing any number of courses of action can be used.

Using a multiple level display, a user of the communication/processing device 410 can be instructed to take an action without knowing the underlying reasons for the action. Similarly stated, the analysis performed at the analysis location can be kept classified while an unclassified action resulting from the analysis is conveyed to the user. For example, the user of the communication/processing device 410 only knows to detain an individual but does not know the identity of that individual.

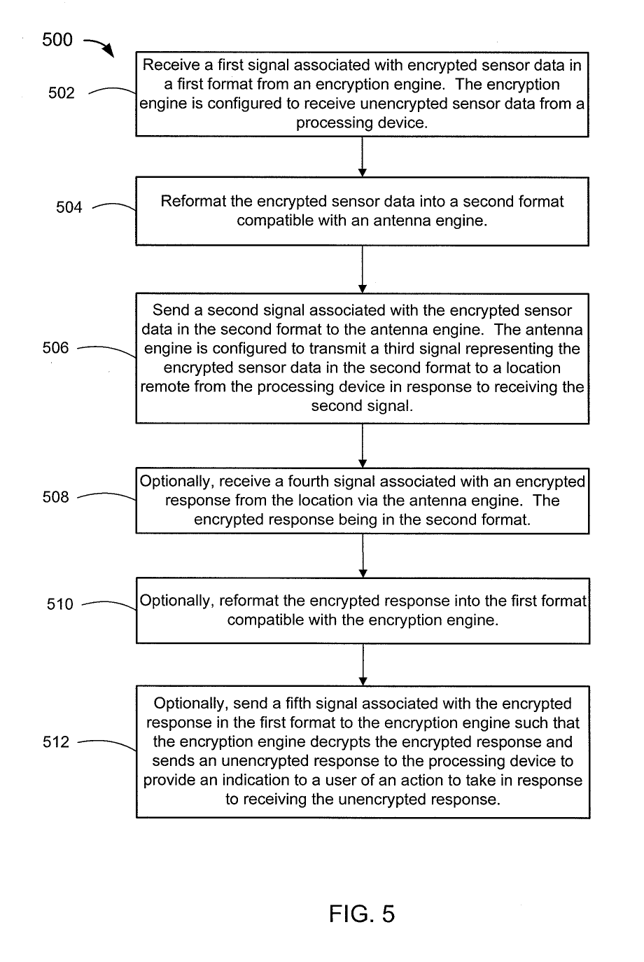

FIG. 5 is a flow chart illustrating a method 500 of transmitting data, according to another embodiment. The method 500 includes receiving a first signal associated with encrypted sensor data in a first format from an encryption engine, at 502. The encryption engine is configured to receive unencrypted sensor data from a processing device and encrypt the unencrypted sensor data. In some embodiments, the encryption engine is a HAIPE device.

The encrypted sensor data is reformatted into a second format compatible with an antenna engine, at 504. In some embodiments, the first format can be an Ethernet format and the second format can be a format in which the antenna engine can transmit the encrypted sensor data over a network. The encrypted sensor data can be reformatted from the Ethernet format into a cellular format. In other embodiments, any suitable format can be used.

A second signal associated with the encrypted sensor data in the second format is sent to the antenna engine, at 506. The antenna engine is configured to transmit a third signal representing the encrypted sensor data in the second format to a location remote from the processing device in response to receiving the second signal. In some embodiments, the third signal can be sent to an analysis location such that the sensor data can be analyzed.

A fourth signal associated with an encrypted response is optionally received from the location, in substantially real-time, via the antenna engine, at 508. The encrypted response is in the second format. The fourth signal can be received from the location in response to the location receiving the third signal. In some embodiments, the sensor data associated with the third signal is analyzed at the location. The encrypted response can be associated with a course of action determined in response to the sensor data.

The encrypted response is optionally reformatted into the first format compatible with the encryption engine, at 510. A fifth signal associated with the encrypted response in the first format is optionally sent to the encryption engine such that the encryption engine decrypts the encrypted response and sends an unencrypted response to the processing device to provide an indication to a user of an action to take in response to receiving the unencrypted response, at 512. As discussed above, the indication provided to the user can be in any suitable format. In some embodiments, for example, a five-level indication is provided to the user. Each of the five levels represents an action to be taken by the user. In such embodiments, the underlying analysis of the sensor data can remain confidential and unknown to the user. In other embodiments, any other number of levels can be used. In still other embodiments, any other type of indicator can be used.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate. For example, while shown and described in FIG. 1 as having a single base station 120, in other embodiments, the network can include any number of base stations.

What is claimed is:

1. A system, comprising:
a mobile base station;
a plurality of sensors configured to collect sensor data; and
a plurality of communication devices, each communication device from the plurality of communication devices being coupled to a sensor from the plurality of sensors, each communication device from the plurality of communication devices being coupled to an encryption engine configured to receive and encrypt data from a sensor from the plurality of sensors,
each communication device configured to send the sensor data from the respective sensor to the mobile base station.

2. The system of claim 1, wherein each communication device from the plurality of communication devices includes a first indicator and a second indicator, at least one of the first indicator or the second indicator being activated in response to a signal received from the base station, the first indicator representing a first action to be taken by a user, the second indicator representing a second action, different from the first action, to be taken by the user.

3. The system of claim 1, wherein the plurality of sensors are distributed throughout a battle zone.

4. The system of claim 1, wherein each sensor from the plurality of sensors is one of a biometric sensor, a vibration sensor, a temperature sensor, or a video camera.

5. The system of claim 1, wherein a sensor from the plurality of sensors is a computer scanner configured to scan a memory of a computer for information.

6. The system of claim 1, wherein the plurality of sensors are legacy sensors retrofitted by being coupled to the plurality of communication devices.

7. The system of claim 1, wherein each communication device from the plurality of communication devices includes an antenna engine operatively coupling that communication device to the cellular network.

8. The system of claim 1, wherein the cellular network is an ad hoc mobile cellular network.

9. The system of claim 1, wherein the encryption engine is a High Assurance Internet Protocol Encryptor (HAIPE).

10. The system of claim 1, wherein each communication device from the plurality of communication devices includes an antenna engine controlled by a processor configured to receive data in a first format from the encryption engine, convert the data into a second format, and send the data in the second format to the antenna engine.

11. The system of claim 1, wherein the encryption engine is removably coupled to the communication device.

12. An apparatus, comprising:
a housing;
an encryption engine configured to encrypt data, the encryption engine being removably disposed within the housing;
an antenna engine configured to operatively couple the apparatus to a mobile cellular network, the antenna engine being disposed within the housing; and
a processor configured to receive data in a first format from the encryption engine, convert the data into a second format, and send the data in the second format to the antenna engine, the processor being disposed within the housing, the antenna engine being configured to send the encrypted data via the mobile cellular network.

13. The apparatus of claim 12, wherein the first format is an Ethernet format and the second format is a cellular format.

14. The apparatus of claim 12, wherein the processor is configured to receive data in the second format from the antenna engine, convert the data into the first format, and send the data in the first format to the encryption engine.

15. The apparatus of claim 12, further comprising:
a display having a first indicator and a second indicator, at least one of the first indicator or the second indicator being activated in response to a signal received by the antenna module, the first indicator representing a first action to be taken by a user, the second indicator representing a second action, different from the first action, to be taken by the user.

16. The apparatus of claim 12, further comprising:
a sensor operatively coupled to the encryption engine, the sensor configured to send sensor data to the encryption module.

17. The apparatus of claim 12, further comprising:
a sensor operatively coupled to the encryption engine, the sensor configured to send sensor data to the encryption module, the sensor being one of a biometric sensor, a vibration sensor, a temperature sensor, or a video camera.

18. The apparatus of claim 12, further comprising:
a display having five indications, at least one of the five indications being displayed on the display in response to a signal received by the antenna module, each indication from the five indications representing an action to be taken by a user.

19. A processor-readable medium storing code representing instructions configured to cause a processor to:
receive a first signal associated with encrypted sensor data in a first format from an encryption engine that received unencrypted sensor data from a processing device;
reformat the encrypted sensor data into a second format compatible with an antenna engine; and
send a second signal associated with the encrypted sensor data in the second format to the antenna engine, the antenna engine configured to transmit a third signal representing the encrypted sensor data in the second format to a location remote from the processing device in response to receiving the second signal.

20. The processor-readable medium of claim 19, the code further comprising code representing instructions configured to cause the processor to:
receive a fourth signal associated with an encrypted response from the location via the antenna engine, the encrypted response being in the second format;
reformat the encrypted response into the first format compatible with the encryption engine; and
send a fifth signal associated with the encrypted response in the first format to the encryption engine such that the encryption engine decrypts the encrypted response and sends an unencrypted response to the processing device to provide an indication to a user of an action to take in response to receiving the unencrypted response.

21. The processor-readable medium of claim 19, the code further comprising code representing instructions configured to cause the processor to:
receive a fourth signal associated with an encrypted response from the location via the antenna engine, the encrypted response being in the second format;
reformat the encrypted response into the first format compatible with the encryption engine; and
send a fifth signal associated with the encrypted response in the first format to the encryption engine such that the encryption engine decrypts the encrypted response and sends an unencrypted response to the processing device to provide an indication to a user of an action to take in response to receiving the unencrypted response, the indication excluding details of an analysis of the encrypted sensor data performed at the location.

22. The processor-readable medium of claim 19, wherein the sensor data includes at least one of biometric sensor data, vibration sensor data, temperature sensor data, or video camera data.

23. The processor-readable medium of claim 19, wherein the processor is collocated with the processing device.

24. The processor-readable medium of claim 19, wherein the encrypted sensor data is transmitted to the location via a mobile cellular network and a satellite network.

25. The processor-readable medium of claim 19, wherein the first format is an Ethernet format and the second format is a cellular format.

26. The processor-readable medium of claim 19, the code further comprising code representing instructions configured to cause the processor to:
receive a fourth signal associated with an encrypted response from the location via the antenna engine, the encrypted response being in the second format;
reformat the encrypted response into the first format compatible with the encryption engine; and
send a fifth signal associated with the encrypted response in the first format to the encryption engine such that the encryption engine decrypts the encrypted response and sends an unencrypted response to the processing device to provide an indication to a user of an action to take in response to receiving the unencrypted response, the indication being one of five different indications.
